(19) United States
(12) Patent Application Publication
(10) Pub. No.: US 2010/0193543 A1
(43) Pub. Date: Aug. 5, 2010

(54) SYSTEM FOR DISPENSING LIQUID COLORING AGENT TO CONCRETE MIXTURES

(76) Inventor: Tim Marchbanks, Douglasville, GA (US)

Correspondence Address: SHELDON MAK ROSE & ANDERSON PC, 100 Corson Street, Third Floor, PASADENA, CA, 91103-3842, US

(21) Appl. No.: 12/365,728

(22) Filed: Feb. 4, 2009

(51) Int. Cl. B67D 5/06; B67D 5/60

(52) U.S. Cl. 222/77; 222/129; 141/83; 141/359

(57) ABSTRACT

A system is provided for dispensing liquid coloring agent to concrete delivery vehicles. The invention includes (a) a plurality of bulk tanks, (b) a weighing vessel connected in fluid tight communication with each bulk tank, and (c) a fill line connecting each weighing vessel to the loading zone. Preferably, the weighing vessel has a capacity between about 40 and about 80 gallons and comprises one or more load cells which communicate to a PLC.

### BACKGROUND

It is common in the concrete mixture production industry to mix a coloring agent with concrete mixtures prior to such mixtures being transported to a job site via ready-mix trucks.

To be sure that the color of the concrete is of the exact shade ordered by the customer, it is critical that the coloring agent be dispensed to the concrete mixture in a precise quantity. One method of attempting to achieve this aim is illustrated in FIG. 1. FIG. 1 illustrates a prior art system comprising four individual bulk tanks, each holding a different coloring agent. In this system 100, the coloring agent is dispensed from each bulk tank 101 (to a truck 102 carrying a concrete mixture) via a metering pump 104. This method, unfortunately, does not always result in a precise amount of coloring agent being added to the concrete mixture. The amount of coloring agent being dispensed via a metering pump tends to vary depending upon the specific gravity of the coloring agent (which typically varies with ambient temperature), any air in the dispensing lines, maintenance problems in the metering pump and any leaks in the dispensing lines 106.

Another prior art of attempting to dispense precise amounts of coloring agents to a concrete mixture is illustrated in FIG. 2. In this system 200, each of the several bulk tanks 201 are connected to a single weighing vessel 204. In the weighing vessel 204, a precise amount of the coloring agent is weighed prior to its being dispensed to a concrete mixture in a delivery truck 206. Although this method is capable of dispensing precise amounts of coloring agent to a concrete mixture, this method is not without problems. Because there is only one weighing vessel, the dispensing of several different coloring agents to trucks carrying different concrete mixtures is a slow process, requiring the repeated transfer of coloring agent from a bulk tank to the single weighing vessel, and further requiring that the weighing vessel be thoroughly rinsed out between uses.

Accordingly, there is a need for a system for providing liquid coloring agent to concrete mixtures within delivery vehicles which avoids the aforementioned problems in the prior art.

### SUMMARY

The invention satisfies this need. The invention is a system for providing liquid coloring agent to concrete delivery vehicles. The invention comprises a system for providing liquid coloring agent to concrete delivery vehicles parked in a loading zone, the system comprising (a) a plurality of bulk tanks, (b) a weighing vessel connected in fluid tight communication with each bulk tank, and (c) a fill line connecting each weighing vessel to the loading zone.

In a preferred embodiment of the invention, the weighing vessel has a capacity between about 40 and about 80 gallons and comprises one or more load cells which communicate to a PLC.

### DRAWINGS

These and other features, aspects and advantages of the present invention will become better understood with reference to the following description, appended claims and accompanying drawings where:

FIG. 1 is a diagrammatic representation of a first prior art system for providing liquid coloring agents to concrete mixtures within concrete delivery vehicles;

FIG. 2 is a diagrammatic representation of a second prior art system for providing liquid coloring agents to concrete mixtures within concrete delivery vehicles;

FIG. 3 is a diagrammatic representation of a system for providing liquid coloring agents to concrete mixtures within concrete delivery vehicles having features of the invention;

FIG. 4 is a diagrammatic representation of a first weighing system useable in weighing vessels employed in the system illustrated in FIG. 3; and

FIG. 5 is a diagrammatic representation of a second weighing system useable in weighing vessels employed in the system illustrated in FIG. 3.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a system 10 for providing liquid coloring agent to concrete mixtures within concrete delivery vehicles 12 vehicles parked in a loading zone 14. The system 10 comprises a plurality of bulk tanks 16 and a weighing vessel 18 associated with each bulk tank 16.

Typically, the system 10 comprises four-eight bulk tanks 16, but fewer bulk tanks 16 or a larger number of bulk tanks 16 can also be used in the system 10. Each bulk tank 16 is a storage tank which typically holds between about 300 and about 500 gallons of liquid coloring agent.

Each weighing vessel 18 in the system 10 typically holds between about 40 and about 80 gallons of liquid coloring agent. This capacity is calculated to allow the user to employ each weighing vessel 18 near about 60% of the capacity of each weighing vessel 18. This, in turn, allows the user to comfortably operate above about 20% of the capacity of each weighing vessel 18 and below about 80% of the capacity of each weighing vessel 18, so as to avoid the drawing of air into a weighing vessel 18 (in the event the weighing vessel 18 is inadvertently emptied) and so as to avoid the inadvertent overfilling a weighing vessel 18. The ability in the user to not have to worry about drawing air into the weighing vessel 18 and overfilling a weighing vessel 18 permits the user to cycle each weighing vessel 18 more quickly. This preferred capacity of the weighing vessels 18 in the system 10 is significantly larger than the typical capacity of prior art systems 10 used in the weighing vessel 18, such as weighing vessel 204 illustrated in FIG. 2. Weighing vessels 18 in such prior art systems 10 typically have a capacity of only about 15 gallons.

Each weighing vessel 18 is mounted on a scale base 20 comprising a mounting plate 22 and one or more load cells 24. Each load cell 24 comprises a transducer capable of converting force into measurable electrical output. In a typical construction, the load cells 24 are strain gauge-based load cells 24. In one embodiment, the load cells 24 are operatively connected to a typical scale head 26 commonly known in the prior art. Such connection scheme is illustrated in FIG. 4 for a single weighing vessel 18.

Preferably, the load cells 24 beneath each weighing vessel 18 are operatively connected as illustrated in FIG. 5. FIG. 5 illustrates this preferred connection scheme for four weighing vessels 18. In this preferred connection scheme, one or more stable direct current supplies 28 are electrically connected to each of the load cells 24 within each of the scale bases 20. A PLC 30 is also operatively coupled to each of the load cells 24 in each of the scale bases 20. In this way, the PLC 30 replaces all scale heads 26 used in the connection scheme illustrated in FIG. 4.

The PLC 30 can directly read voltage changes between each of the load cells 24 because of the attached stable direct current power supply 28 which provides an accurate measure of pigment within the weighing vessel 18. The PLC 30 can measure pigment within about 45 grams of the desired amount. The connection scheme illustrated in FIG. 5 reduces capital costs associated with similar systems 10 applying the connection scheme illustrated in FIG. 4 by a very significant amount, thereby reducing the overall installation costs of the system 10 by 25%-50% of similar installation systems 10 applying a connection scheme such as illustrated in FIG. 4. For example, in one typical installation, the overall cost of the installation using the connection system 10 illustrated in FIG. 4 might be $70,000-$80,000, wherein an otherwise identical installation employing the connection scheme illustrated in FIG. 5 would likely only cost between about $40,000-$50,000.

Moreover, the connection scheme illustrated in FIG. 5 is considerably easier to install since each of the plurality of scale heads 26, if connected as illustrated in FIG. 4, would have to be calibrated separately. In the connection scheme illustrated in FIG. 5, on the other hand, the calibration of all of the weighing vessels 18 are self-calibrating.

Finally, the connection scheme illustrated in FIG. 5 eliminates the need for scale heads 26 as potential failure points—thereby considerably reducing maintenance costs in the system 10 and increasing the system's reliability.

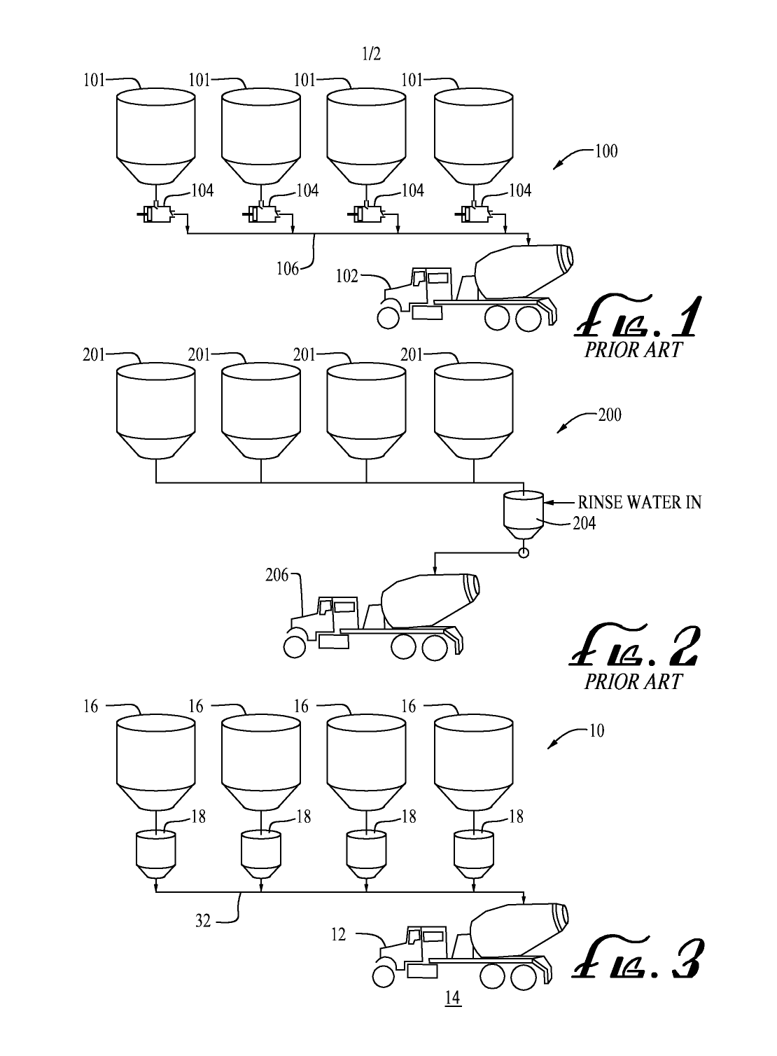

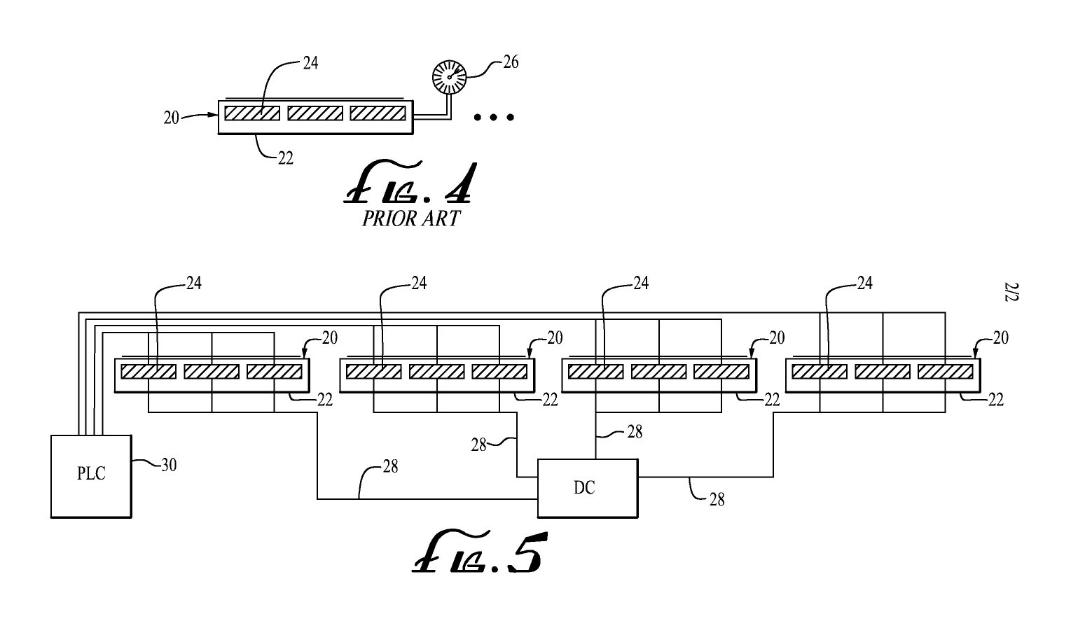

As illustrated in FIG. 3, the system 10 further comprises a fill line 30 connecting each weighing vessel 18 to the loading zone 14. Typically, the fill line 30 comprises a pump (not shown), but any such pump need not be a metering pump such as is required in many prior art systems, such as the system 100 illustrated in FIG. 1.

In operation, coloring agent from each bulk tank 16 is transferred to a weighing vessel 18 in an amount approximately equal to 60% of the capacity of such weighing vessel 18. Thereafter, as trucks 12 carrying concrete mixtures arrive at the loading zone 14 for a respective coloring agent, coloring agent is quickly transferred from the appropriate weighing vessel 18 to the truck 12 without having to waste time worrying about whether the weighing vessel 18 might be completely depleted (so as to risk drawing air into the weighing vessel 18) and, as the weighing vessel 18 is re-filled after transferring an appropriate designated quantity of coloring agent to a waiting ready-mix truck, not having to worry about whether the weighing tank 18 is being inadvertently overfilled. Adding coloring agent to a second truck 12 which immediately follows the first truck 12 is also made faster in the system 10 of the invention due to the fact that no time need be wasted in rinsing out a weighing vessel 18 with water.

The system 10 of the invention is accordingly considerably less expensive to build and maintain than systems of the prior art. It provides faster loading operation into waiting trucks and it provides an accuracy of measurement considerably better than most systems of the prior art.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A system for providing liquid coloring agent to concrete delivery vehicles parked in a loading zone, the system comprising:
(a) a plurality of bulk tanks;
(b) a weighing vessel connected in fluid tight communication with each bulk tank; and
(c) a fill line connecting each weighing vessel to the loading zone.

2. The system of claim 1 wherein the capacity of each weighing vessel is between about 40 and about 80 gallons.

3. The system of claim 1 wherein the weighing vessel comprises one or more load cells which communicate to a PLC.

4. A system for providing liquid coloring agent to concrete delivery vehicles parked in a loading zone, the system comprising:
(a) a plurality of bulk tanks;
(b) a weighing vessel connected in fluid tight communication with each bulk tank, the weighing vessel having a capacity between about 40 and about 80 gallons and comprising one or more load cells which communicate to a PLC; and
(c) a fill line connecting each weighing vessel to the loading zone.
